(19) United States
(12) Patent Application Publication
(10) Pub. No.: US 2026/0361958 A1
(43) Pub. Date: Nov. 12, 2026

(54) VIDEO DISTRIBUTION

(71) Applicants: Bytedance Technology Ltd., Grand Cayman (KY); Beijing Zitiao Network Technology Co., Ltd., Beijing (CN)

(72) Inventors: Yabin ZHANG, Los Angeles, CA (US); Guiyan Cao, Beijing (CN); Yang Li, Beijing (CN); Jianzhao Liu, Beijing (CN); Shasha Wang, Beijing (CN); Shuhui Chen, Beijing (CN); Siyi Gu, Beijing (CN); Mu Zhu, Beijing (CN); Qianyun Ma, Culver City, CA (US); Qian Chen, Culver City, CA (US); He Liu, Los Angeles, CA (US); Yiting Liao, Los Angeles, CA (US); Junlin Li, Los Angeles, CA (US)

(21) Appl. No.: 19/466,126

(22) Filed: Jan. 30, 2026

(30) Foreign Application Priority Data
May 8, 2025 (CN) 202510595943.1

(51) Int. Cl. H04N 21/462; G06T 3/4053; H04N 21/4402

(52) U.S. Cl. CPC H04N 21/4621; G06T 3/4053; H04N 21/440218

(57) ABSTRACT

Embodiments of the disclosure relate to a video distribution method, an apparatus, a device, and a storage medium. The method proposed here includes: determining, using a first evaluation model, a first quality metric of a target video to be distributed; converting the target video into a plurality of first videos corresponding to a plurality of transcoding modes, the plurality of transcoding modes corresponding to different video encoding attributes; determining, using a second evaluation model, quality loss information of the plurality of first videos with respect to the target video; determining a plurality of second quality metrics of the plurality of first videos based on the quality loss information; and providing reference information associated with distribution of the target video based at least on the first quality metric and the plurality of second quality metrics.

### CROSS-REFERENCE

This application claims priority to Chinese Patent Application No. 202510595943.1, filed on May 8, 2025, and entitled “METHOD, APPARATUS, DEVICE, AND STORAGE MEDIUM FOR VIDEO DISTRIBUTION”, which is incorporated herein by reference in its entirety.

### TECHNICAL FIELD

Example embodiments of the present disclosure generally relate to the field of computers, and in particular, to video distribution.

### BACKGROUND

With the increasing maturity of network technologies, more and more users browse or upload video content on network platforms. A network platform needs to process video content uploaded by a user or monitor image quality of the video content. However, image quality monitoring of the video content uploaded by the user to the network platform based on existing technologies requires huge computing resources, and image quality monitoring or recording cannot be performed on the video content in different processing stages, resulting in low efficiency of distributing video content.

### SUMMARY

In a first aspect of the present disclosure, a video distribution method is provided. The method includes: determining, using a first evaluation model, a first quality metric of a target video to be distributed; converting the target video into a plurality of first videos corresponding to a plurality of transcoding modes, the plurality of transcoding modes corresponding to different video encoding attributes; determining, using a second evaluation model, quality loss information of the plurality of first videos with respect to the target video; determining a plurality of second quality metrics of the plurality of first videos based on the quality loss information; and providing reference information associated with distributing the target video based at least on the first quality metric and the plurality of second quality metrics.

In a second aspect of the present disclosure, an apparatus for video distribution is provided. The apparatus includes: a first determination module configured to determine, using a first evaluation model, a first quality metric of a target video to be distributed; a converting module configured to convert the target video into a plurality of first videos corresponding to a plurality of transcoding modes, the plurality of transcoding modes corresponding to different video encoding attributes; a second determination module configured to determine, using a second evaluation model, quality loss information of the plurality of first videos with respect to the target video; a third determination module configured to determine a plurality of second quality metrics of the plurality of first videos based on the quality loss information; and a providing module configured to provide reference information associated with distributing the target video based at least on the first quality metric and the plurality of second quality metrics.

In a third aspect of the present disclosure, an electronic device is provided. The device includes at least one processor; and at least one memory coupled to the at least one processor and storing instructions executable by the at least one processor, the instructions, when executed by the at least one processor, causing the device to perform the method of the first aspect.

In a fourth aspect of the present disclosure, a non-transitory computer-readable storage medium is provided. The non-transitory computer-readable storage medium stores a computer program executable by a processor to implement the method of the first aspect.

It should be understood that content described in this summary is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The foregoing and other features, advantages, and aspects of the embodiments of the present disclosure will become more apparent with reference to the following detailed description and in conjunction with the drawings. In the drawings, the same or similar reference signs denote the same or similar elements.

FIG. 1 illustrate a schematic diagram of an example environment in which the embodiments according to the present disclosure may be implemented;

FIG. 2 illustrate a flowchart of an example process for video quality determination according to some embodiments of the present disclosure;

FIG. 3 illustrate a flowchart of an example process of using a second evaluation model according to some embodiments of the present disclosure;

FIG. 4 illustrate a flowchart of an example process for video distribution according to some embodiments of the present disclosure;

FIG. 5 illustrate a schematic structural block diagram of an example apparatus for video distribution according to some embodiments of the present disclosure; and

FIG. 6 illustrate a block diagram of an electronic device capable of implementing a plurality of embodiments of the present disclosure.

### DETAILED DESCRIPTION OF EMBODIMENTS

The embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. On the contrary, these embodiments are provided for more thorough and complete understanding of the present disclosure. It should be understood that the drawings and embodiments of the present disclosure are only used for illustrative purposes, and are not used to limit the protection scope of the present disclosure.

It should be noted that the titles of any section/subsection provided herein are not restrictive. Various embodiments are described throughout this specification, and any type of embodiment may be included in any section/subsection. In addition, the embodiments described in any section/subsection may be combined with any other embodiments described in the same section/subsection and/or different section/subsection in any manner.

In the description of the embodiments of the present disclosure, the term “include/comprise”, and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or same objects. Other explicit and implicit definitions may also be included below.

The embodiments of the present disclosure may involve user data, data acquisition and/or data use. These aspects all follow corresponding laws, regulations and related provisions. In the embodiments of the present disclosure, all data collection, acquisition, processing, forwarding, and use are performed on the premise that the user knows and confirms. Accordingly, when implementing the embodiments of the present disclosure, the user should be informed of the type, range of use, use scenarios, etc. of the data or information that may be involved, and the authorization of the user should be obtained in an appropriate manner in accordance with relevant laws and regulations. The specific manner of informing and/or authorizing may vary according to actual situations and application scenarios, and the scope of the present disclosure is not limited in this regard.

If the solutions in this specification and the embodiments involve personal information processing, the processing will be performed on the premise that there is a legal basis (for example, the consent of the personal information subject is obtained, or it is necessary for the performance of a contract, etc.), and the processing will only be performed within the scope of the provisions or agreements. If a user refuses to process personal information other than the necessary information required for the basic functions, it will not affect the user's use of the basic functions.

As mentioned above, with the increasing maturity of network technologies, more and more users browse or upload video content on network platforms. A network platform needs to process video content uploaded by a user or monitor image quality of the video content. However, image quality monitoring of the video content uploaded by the user to the network platform based on existing technologies requires huge computing resources, and image quality monitoring or recording cannot be performed on the video content in different processing stages, resulting in low efficiency of distributing video content.

The embodiment of the present disclosure provides a solution for video distribution. According to this solution, a first quality metric of a target video to be distributed may be determined using a first evaluation model. The target video may be converted into a plurality of first videos corresponding to a plurality of transcoding modes, wherein the plurality of transcoding modes correspond to different video encoding attributes. Quality loss information of the plurality of first videos with respect to the target video may be determined using a second evaluation model. A plurality of second quality metrics of the plurality of first videos may be determined based on the quality loss information; and reference information associated with distributing the target video may be provided based on at least the first quality metric and the plurality of second quality metrics.

In this way, the embodiments of the present disclosure can determine a first quality metric of a target video to be distributed and a plurality of second quality metrics of a plurality of videos corresponding to a plurality of transcoding modes after the target video is converted, so that quality monitoring may be provided for different steps of video processing. In addition, the embodiments of the present disclosure can provide the reference information associated with distributing the target video based on the first quality metric and the plurality of second quality metrics, to provide data reference for a process of distributing videos, thereby ensuring the quality and efficiency of distributed videos. Moreover, the quality of the video in different processing steps are determined based on a first evaluation model and a second evaluation model, respectively, so that quality evaluation may be supported for videos in different processing steps, which is beneficial to improving the efficiency of quality monitoring of each step of the video processing, and providing a reference for subsequent optimization of the video conversion mode.

Various example implementations of this solution will be described in detail below in further with reference to the drawings.

### EXAMPLE ENVIRONMENT

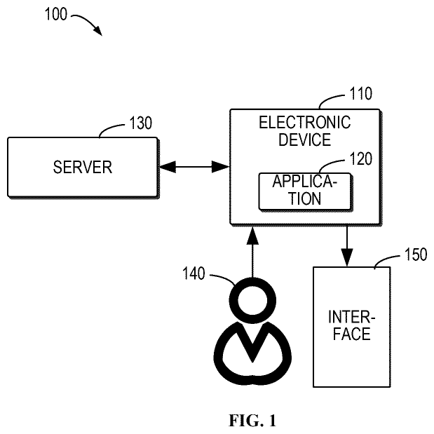

FIG. 1 illustrate a schematic diagram of an example environment 100 in which the embodiments of the present disclosure may be implemented. As shown in FIG. 1, the example environment 100 may include an electronic device 110.

In the example environment 100, an application 120 supporting interface interaction may be run on the electronic device 110. The application 120 may be any appropriate type of application for interface interaction, examples of which may include but are not limited to: a media application, a video application, a social application, or another appropriate application. A user 140 may interact with the application 120 via the electronic device 110 and/or its attached device.

In the environment 100 of FIG. 1, if the application 120 is in an active state, the electronic device 110 may present an interface 150 for supporting publishing and viewing of video content through the application 120.

In some embodiments, the electronic device 110 communicates with a server 130 to implement provision of the service of the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR (Virtual Reality)/AR (Augmented Reality) device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including the fittings and peripherals of these devices or any combination thereof. In some embodiments, the electronic device 110 may also support any type of user-specific interface (such as a “wearable” circuit, etc.).

The server 130 may be a standalone physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and so on. The server 130 may provide a backend service for the application 120 that supports interface interaction in the electronic device 110.

A communication connection may be established between the server 130 and the electronic device 110. The communication connection may be established by a wired or wireless method. The communication connection may include but is not limited to a Bluetooth connection, a mobile network connection, a universal serial bus (USB) connection, a wireless fidelity (Wi-Fi) connection, etc., and the embodiments of the present disclosure are not limited in this regard. In the embodiments of the present disclosure, the server 130 and the electronic device 110 may implement signaling interaction through the communication connection in between.

It should be understood that the structure and function of each element in the environment 100 are described for illustrative purposes only, and do not imply any limitation to the scope of the present disclosure.

Some example embodiments of the present disclosure will continue to be described below with reference to the drawings.

### EXAMPLE VIDEO QUALITY DETERMINATION

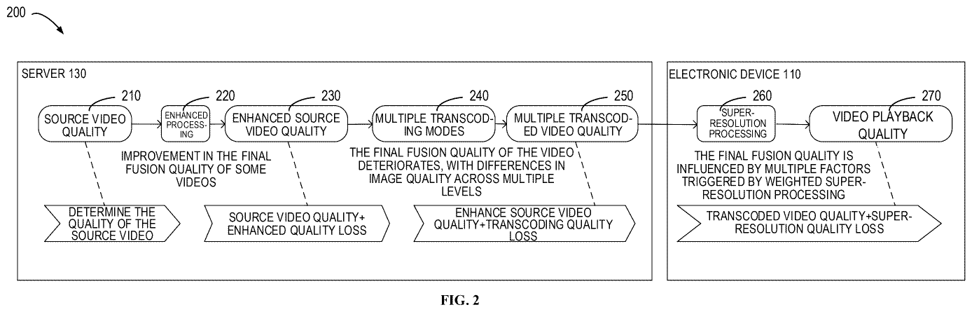

FIG. 2 illustrate a flowchart of an example process 200 for video quality determination according to some embodiments of the present disclosure. The process 200 may be implemented at the electronic device 110 or the server 130. The process 200 is described below with reference to FIG. 1.

As shown in FIG. 2, the server 130 (for example, also referred to as a server-side) may determine a quality of an acquired target video (for example, also referred to as a source video, an original video, etc.). Further, the server 130 may also perform enhancement processing on the target video, perform conversion based on a plurality of transcoding modes, etc. In addition, the server 130 may also determine the quality of the target video after the enhancement processing and/or the conversion based on the plurality of transcoding modes, respectively. Alternatively, the server 130 may distribute the processed target video or the unprocessed target video to the electronic device 110 (for example, also referred to as a playback-side). The electronic device 110 may receive the video content from the server 130, and support directly playing the video content or processing the video content and then playing the video content. For example, the processing of the video content by the electronic device 110 includes but is not limited to super-resolution processing (for example, adjusting the video content from low resolution to high resolution, for example, adjusting the video content from 720p to 1080p). In addition, the electronic device 110 or the server 130 may also determine the image quality of the video content after the super-resolution processing. In this way, based on the embodiments of the present disclosure, the capability of perceiving the image quality of the video content in the entire link can be provided, so that the video quality of each step of the video processing can be measured and tracked, thereby improving the efficiency of video processing and distribution.

Next, an example description is provided for video quality (for example, Ultimate Fusion Quality (UFQ)) determination and the video processing process based on FIG. 2.

At block 210, the server 130 may determine image quality (for example, UFQ_{src}) of a source video (for example, Source video). For example, the source video (for example, also referred to as a target video, original video content, etc.) here may include video content (for example, user generated content (UGC)) uploaded by a user via the application 120 and/or video content stored in the service 130. As an example, the server 130 may determine a first quality metric (or referred to as source video image quality) of the target video to be distributed using a first evaluation model.

As an example, the first evaluation model may be implemented as a prediction model corresponding to Video Quality Score (VQScore). As an example, such a first evaluation model, for example, may correspond to a no-reference evaluation mode. As an example, the no-reference evaluation mode may indicate that the quality of the input video may be assessed based only on information of the input video itself without using a reference video. As an example, the information of the input video itself here may include, for example, an internal feature (for example, texture, noise, etc.) of the input video. An evaluation mode opposite to the no-reference evaluation mode may include, for example, a full-reference evaluation mode. As an example, the full-reference evaluation mode needs to assess a quality of the input video to be evaluated based on a reference video. For example, a model corresponding to the full-reference evaluation mode may compare the reference video with the input video to be evaluated pixel by pixel or frame by frame to assess the quality of the input video to be evaluated. For example, feature information of the reference video and the input video to be evaluated involved in the full-reference evaluation mode may include a peak signal-to-noise ratio (PNSR), structural similarity (SSIM), and the like.

The server 130 may assess the first quality metric of the source video (for example, src) based on the first evaluation model. For example, a calculation process of the first quality metric may be expressed as:

UFQ_{src}=}₁(VQScore_{src})¿

where UFQ_{src} may indicate the first quality metric of the source video, }1( )¿ may indicate linear mapping, and VQScore_{src} may indicate that the quality of the source video is assessed based on VQScore.

As an example, VQScore is a general no-reference video or no-reference image quality evaluation indicator (for example, an image quality (for example, image clarity) evaluation indicator). A value range of the first quality metric determined based on VQScore may be, for example, 0 to 100. The higher the value, the better the quality of the video or image. As an example, such a first evaluation model may output the first quality metric between 0 and 100 for the target video. For example, a first quality metric between 0 and 60 indicates that the quality of the target video is poor, a first quality metric between 60 and 70 indicates that the quality of the target video is normal, and a first quality metric between 70 and 100 indicates that the quality of the target video is good.

As an example, such a first evaluation model is trained based on a plurality of datasets. For example, such a plurality of datasets may include a self-built dataset, an open-source dataset, and/or a synthetic auxiliary dataset. Such a plurality of datasets may include different video contents and quality levels, which can ensure generalization capability of the model. Further, a subjective evaluation score corresponding to the dataset is determined based on Mean Opinion Score (MOS). Further, the server 130 may perform feature extraction on the input video or image using a deep learning model (for example, a backbone convolutional neural network), and concatenate and fuse multi-level features for subjective evaluation score regression training to obtain the first evaluation model.

Alternatively, at block 220, the server 130 may perform video enhancement processing on the target video to obtain a second video. As an example, such video enhancement processing may include denoising, sharpening, and/or color correction of the target video. Further, at block 230, the server 130 may determine enhanced source video image quality. As an example, the server 130 may determine a reference quality metric of the second video using the first evaluation model. Further, the server 130 may determine a third quality metric (for example, also referred to as enhanced source video image quality) of the second video based on a quality difference between the reference quality metric and the first quality metric. As an example, the third quality metric may be obtained by mapping the quality difference to the third quality metric of the second video based on a predetermined mapping. For example, a calculation process of the third quality metric may be expressed as:

UFQₑₙₕ=}₂(VQScore_{src}, VQScoreₑₙₕ)¿

where UFQₑₙₕ may indicate the third quality metric of the second video, }2( )¿ may indicate linear mapping of the quality difference, VQScore_{src} may indicate that the quality of the source video is assessed based on VQScore, and VQScoreₑₙₕ may indicate that the quality of the second video is assessed based on VQScore.

At block 240, the server 130 may convert the target video or the second video into a plurality of first videos corresponding to a plurality of transcoding modes. As an example, if the target video is not enhanced, the server 130 directly converts the target video into the plurality of first videos corresponding to the plurality of transcoding modes. Alternatively, after the server 130 performs the enhancement processing on the target video to obtain the second video, the server 130 may convert the second video into the plurality of first videos corresponding to the plurality of transcoding modes.

As an example, the plurality of transcoding modes may correspond to different video encoding attributes. As an example, the encoding attribute may include at least one of video resolution, a video encoding mode, and a video encoding rate. As an example, the plurality of encoding modes may include, for example, 1080p_mode1_veryslow, 720p_mode2_medium, and 540p_mode2_medium, etc. Taking 1080p_mode1_veryslow as an example, this transcoding mode may indicate that the transcoded video has a resolution of 1080p (for example, 1920×1080 pixels), a video encoding mode is a first encoding mode corresponding to mode1 (for example, the first encoding mode indicates encoding based on a first encoding protocol), and a video encoding rate is veryslow. Taking 720p_mode2_medium as an example, this transcoding mode may indicate that the transcoded video has a resolution of 720p (for example, 1280×720 pixels), a video encoding mode is a second encoding mode corresponding to mode2 (for example, the second encoding mode indicates encoding based on a second encoding protocol), and a video encoding rate is medium.

At block 250, the server 130 may determine image quality (for example, UFQ_trans) of a plurality of transcoded videos. As an example, the server 130 may determine quality loss information of the plurality of first videos with respect to the target video using a second evaluation model. Further, the server 130 may determine a plurality of second quality metrics of the plurality of first videos based on the quality loss information.

As an example, the second evaluation model may be implemented by, for example, a quality assessment model corresponding to Multiverse Video Multimethod Assessment Fusion (mVMAF). For example, the second evaluation model is obtained through training based on, for example, Video Multimethod Assessment Fusion (VMAF). As an example, the quality assessment model corresponding to mVMAF may be used to predict VMAF values of videos in different resolutions, encoders, rendering resolutions, and on-device super-resolution resolutions. As an example, the model corresponding to VMAF may extract a variety of features from the input video and the reference video, such as Visual Information Fidelity (VIF), Detail Loss Metric (DLM), Temporal Information (TI), brightness, contrast, and/or color, and the like. Further, the model corresponding to VMAF may fuse the extracted features (for example, using a support vector machine or another regression model) to obtain the quality score for the input video. As an example, VMAF may correspond to the full-reference evaluation mode, which is not described herein again for the full-reference evaluation mode. As an example, the second evaluation model obtained through training based on VMAF also corresponds to the full-reference evaluation mode.

As an example, the server 130 may convert a first sample video in a sample set into a plurality of second sample videos corresponding to a plurality of transcoding modes based on a constant rate factor (CRF) in a predetermined range (for example, 20 to 35). As an example, the constant rate factor is a parameter used to control video encoding quality and file size. For example, if there are 16 constant rate factors in the 20 to 35 range and 6 transcoding modes, the number of second sample videos generated based on the first sample video is 96. Further, the server 130 may process the plurality of second sample videos using the model corresponding to VMAF to generate a plurality of quality scores corresponding to the a plurality of second videos, wherein the second sample videos processed based on different transcoding modes correspond to different encoding features. The server 130 may obtain the second evaluation model through training based on a prediction model (for example, a Gradient Boosting Decision Tree (GBDT)) based on encoding features of the sample set and quality scores of transcoding modes corresponding to the encoding features of the sample set. In this way, the second evaluation model may generate, based on the input video and an encoding feature of the input video corresponding to a target transcoding mode, a quality score corresponding to a video obtained after the input video is converted based on the target transcoding mode.

Alternatively, the electronic device 110 may further perform rendering resolution and playback terminal super-resolution processing on a sample video in the sample set. For example, for a third sample video in the sample set, a resolution corresponding to a fourth sample video converted based on the target transcoding mode is 1080p. A rendering resolution of the electronic device 110 (for example, a playback terminal) for the fourth video is 960p, and a resolution corresponding to super-resolution is 1080p. The server 130 or the electronic device 110 may use the model corresponding to VMAF to generate a corresponding quality score based on feature information of the fourth video during super-resolution playback on the electronic device 110 and/or an encoding feature of the third sample video corresponding to the target transcoding mode. The server 130 or the electronic device 110 may obtain the second evaluation model through training based on a prediction model (for example, a Gradient Boosting Decision Tree (GBDT)) based on the encoding features of the sample set, the feature information corresponding to super-resolution, and/or a quality score corresponding to the super-resolution processing of the sample set. In this way, the second evaluation model may generate, based on the encoding feature of the input video and the feature information of the input video after super-resolution processing, a quality score corresponding to the input video after super-resolution processing.

In some embodiments, the server 130 may determine, using the second scoring model, a plurality of quality scores of the plurality of first videos based on encoding features of the plurality of first videos corresponding to the plurality of transcoding modes. Further, the server 130 may determine the quality loss information of the plurality of first videos with respect to the target video. As an example, the server 130 may determine an encoding feature associated with the target video or the second video by pre-encoding the target video or the second video (for example, the second video is determined by performing video enhancement processing on the target video). Further, the server 130 may provide the encoding feature to the second evaluation model to determine the quality loss information of the plurality of first videos with respect to the target video. For example, the server 130 may determine, using the second evaluation model, quality scores of the plurality of first videos associated with the plurality of transcoding modes based on a plurality of encoding features corresponding to the plurality of transcoding modes, to determine the quality loss information of the plurality of first videos with respect to the target video. As an example, a value range of the quality score here may be 0 to 100. As an example, a value range of the plurality of second quality metrics of the plurality of first videos determined based on the quality loss information may be the same as a value range of the first quality metric, for example, both are 0 to 100.

For example, the quality loss information may include a plurality of quality losses of the plurality of first videos with respect to the target video. For example, taking a video A in the plurality of first videos as an example, a calculation process of a quality loss of the video A with respect to the target video may be expressed as:

UFQₜᵣₐₙₛₗₒₛₛ=}₃(mVMAF_{VA})¿

where UFQₜᵣₐₙₛₗₒₛₛ may indicate the quality loss of the video A, }₃( )¿ may indicate linear mapping, and mVMAF_{VA} may indicate a quality loss of the video A with respect to the target video assessed based on mVMAF.

Further, the server 130 may determine the plurality of second quality metrics of the plurality of first videos based on the quality loss information. For example, still using the video A as an example, a calculation process of the second quality metric corresponding to the video A may be expressed as:

UFQ_{transA}=UFQ_{src}+UFQₜᵣₐₙₗₒₛₛ

where UFQ_{transA} may indicate the second quality metric corresponding to the video A, UFQ_{src} may indicate the first quality metric of the source video, and UFQₜᵣₐₙₛₗₒₛₛ may indicate the quality loss of the video A.

Alternatively, if the plurality of second videos are obtained through transcoding based on the second video after the enhancement processing is performed on the target video, the server 130 may determine the plurality of second quality metrics of the plurality of first videos based on the quality loss information of the plurality of first videos with respect to the target video and the third quality metric of the second video. For example, still using the video A as an example, the calculation process of the second quality metric corresponding to the video A may be expressed as:

UFQₜᵣₐₙₛ=UFQₑₙₕ+UFQₜᵣₐₙₗₒₛₛ

where UFQₜᵣₐₙₛ may indicate the second quality metric corresponding to the video A, UFQₑₙₕ may indicate the third quality metric of the second video, and UFQₜᵣₐₙₗₒₛₛ may indicate the quality loss of the video A.

In some embodiments, the server 130 may provide the reference information associated with distributing the target video based at least on the first quality metric and the plurality of second quality metrics. As an example, such reference information may include a video distribution recommendation generated based on the first quality metric and the plurality of second quality metrics. For example, such a video distribution recommendation may indicate resolution reference information suitable for the video. Alternatively, after the video enhancement processing is performed on the target video, the reference information may also be determined based on the third quality metric.

In some embodiments, the server 130 may present the reference information in a graphical interface. The reference information includes at least the first quality metric, the plurality of second quality metrics, and/or the third quality metric. As an example, the server 130 may support presenting the first quality metric, the plurality of second quality metrics, and/or the third quality metric in a visual manner for background data analysis and quality monitoring, thereby improving the efficiency of video distribution.

In some embodiments, the reference information is further determined based on a fourth quality metric associated with playback of a third video corresponding to the target video by a client (for example, the electronic device 110). The third video here is determined based on the first video received by the client from the server 130. As an example, the first video here may be one of the plurality of first videos.

As an example, when the electronic device 110 does not perform the super-resolution processing on the first video, the third video here may be equivalent to the first video. For example, a calculation process of the fourth quality metric associated with the third video may be expressed as:

UFQ_{pb}=UFQₜᵣₐₙₛ₁

where UFQ_{pb} may indicate the fourth quality metric associated with the third video, and UFQₜᵣₐₙₛ₁ may indicate the second quality metric of the first video.

As an example, at block 260, the electronic device 110 (for example, also referred to as a playback terminal) may perform super-resolution processing on the first video to determine the third video. As an example, the super-resolution processing here may indicate that the first video is adjusted from a first resolution (for example, 960p) to a second resolution (for example, 1080p). For example, the second resolution is higher than the first resolution. The server 130 or the electronic device 110 may determine quality evaluation information (for example, a third quality metric associated with the third video) of the third video using the second evaluation model, and determine super-resolution evaluation information associated with the first video using a third evaluation model, in response to the electronic device 110 (for example, also referred to as a playback terminal or a client) performing super-resolution processing on the received first video to determine the third video. Further, the server 130 or the electronic device 110 may determine the fourth quality metric associated with the third video based on the quality evaluation information and the super-resolution evaluation information. For example, the calculation process of the fourth quality metric associated with the third video may be expressed as:

UFQ_{pb}=UFQₑₙₕ+}₄(mVMAF₃, SRclass₁)¿

where UFQ_{pb} may indicate the fourth quality metric associated with the third video, UFQₑₙₕ may indicate the third quality metric associated with the second video (alternatively, if the target video (or referred to as the source video) is not enhanced, UFQₑₙₕ here may be replaced with UFQ_{src}, and UFQ_{src} may indicate the first quality metric of the source video), }₄( )¿ may indicate linear mapping, mVMAF_{VA} may indicate the quality evaluation information of the third video assessed based on mVMAF, and SRclass₁ may indicate the super-resolution evaluation information of the first video assessed based on SRclass.

As an example, the third evaluation model may be implemented as a model corresponding to SRclass. As an example, the model corresponding to SRclass may be a model that predicts super-resolution downshifting potential based on the source video. For example, the model corresponding to SRclass may be used to determine whether a video in a low definition (for example, a resolution of 720p) may be replaced with a video in a high definition (for example, a resolution of 1080p) through super-resolution. As an example, the third evaluation model may generate corresponding super-resolution evaluation information (for example, a potential score) based on the input video. As an example, a value range of such super-resolution evaluation information may be, for example, 0 to 100. The higher the value, the better the super-resolution evaluation information. For example, when the super-resolution evaluation information corresponds to 0 to 45, it indicates that the video cannot perform corresponding super-resolution processing. When the super-resolution evaluation information corresponds to 45 to 60, it indicates that the video may be replaced from 720p to 1080p based on super-resolution processing. When the super-resolution evaluation information corresponds to 60 to 100, it indicates that the video may be replaced from 540p to 1080p based on super-resolution processing.

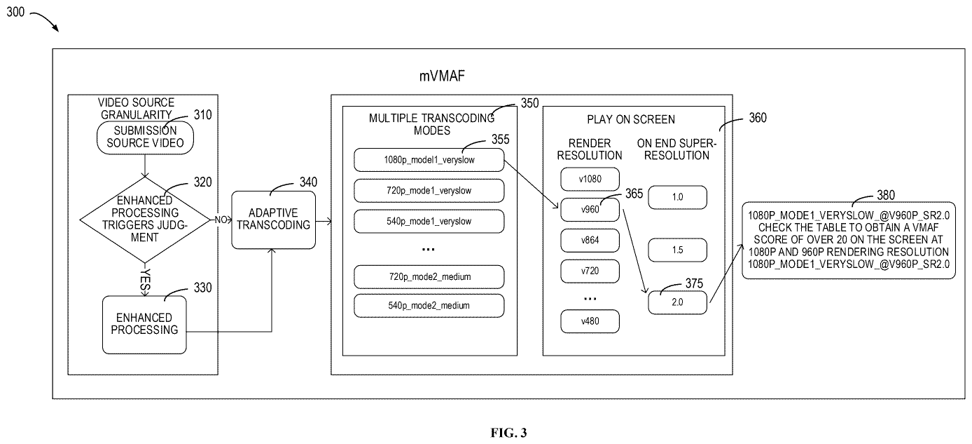

An example description is provided below for a process of using the second evaluation model based on FIG. 3. FIG. 3 illustrates a flowchart of an example process 300 of using a second evaluation model according to some embodiments of the present disclosure. The process 300 may be implemented at the server 130. The process 300 is described below with reference to FIG. 1.

At block 310, the server 130 may acquire a submitted source video. Such a source video may include, for example, a video uploaded by a user via the application 120.

At block 320, the server 130 may determine whether to perform enhancement processing on the source video. As an example, a basis for the determining process may include, for example, noise information, image quality clarity, or the like of the source video.

At block 330, the server 130 may perform video enhancement processing on the source video in response to the determination result indicating that the enhancement processing needs to be performed on the source video. Such video enhancement processing may include denoising, sharpening, and/or color correction of the target video.

At block 340, the server 130 may perform adaptive transcoding on the source video or the enhanced source video in response to the determination result indicating that the enhancement processing does not need to be performed on the source video or the enhancement processing process on the source video is completed. As an example, the adaptive transcoding here may indicate transcoding the source video or the enhanced source video based on the plurality of transcoding modes described above, to generate a plurality of transcoded videos corresponding to the plurality of transcoding modes.

At block 350, the plurality of transcoding modes may include, for example, 1080p_mode1_veryslow, 720p_mode1_veryslow, and 540p_mode1_veryslow, etc. At block 355, taking 1080p_mode1_veryslow as an example, this transcoding mode may indicate that the transcoded video has a resolution of 1080p (for example, 1920×1080 pixels), a video encoding mode is a first encoding mode corresponding to mode 1 (for example, the first encoding mode indicates encoding based on a first encoding protocol), and a video encoding rate is veryslow.

At block 360, the electronic device 110 may play a corresponding video based on the rendering resolution and/or on-device super-resolution processing. For example, at block 365, a rendering resolution of the electronic device 110 for the transcoded video from the server 130 is 960p. At block 375, a super-resolution multiple of the super-resolution processing determined via the electronic device 110 is 2.0, that is, the transcoded video is converted from a rendering resolution of 960p to a resolution of 1080p.

At block 380, the electronic device 110 or the server 130 may determine quality evaluation information of the video based on the super-resolution processing using the model corresponding to mVMAF.

Based on the process described above, in this way, the embodiments of the present disclosure can determining the first quality metric of the target video to be distributed, the plurality of second quality metrics of the plurality of videos corresponding to the a plurality of transcoding modes after the target video is converted, the third quality metric of the video after the enhancement processing is performed on the target video, and the fourth quality metric after the transcoded video is subjected to super-resolution processing at the client, so that quality monitoring may be provided for different steps of video processing. In addition, the embodiments of the present disclosure can providing the reference information associated with distribution of the target video based on the first quality metric, the plurality of second quality metrics, the third quality metric, and the fourth quality metric, to provide data reference for a process of distributing videos, thereby ensuring the quality and efficiency of distributed videos. In addition, the quality of the video in different processing steps are determined based on the first evaluation model, the second evaluation model, and the third evaluation information, respectively, so that quality evaluation may be supported for videos in different processing steps, which is beneficial to improving the efficiency of quality monitoring of each step of the video processing, and providing a reference for subsequent optimization of the video conversion mode.

### EXAMPLE PROCESS

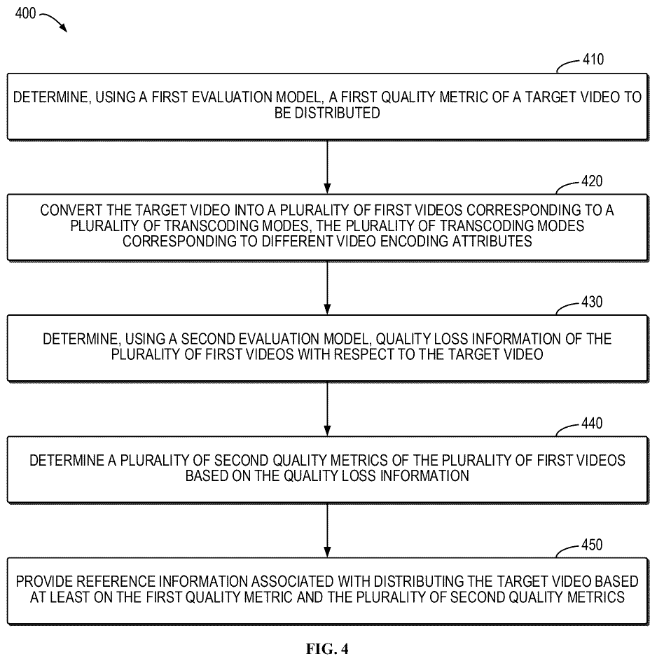

FIG. 4 illustrates a flowchart of an example process 400 of video distribution according to some embodiments of the present disclosure. The process 400 may be implemented at the server 130 and/or the electronic device 110. The process 400 is described below with reference to FIG. 1.

As shown in FIG. 4, at block 410, the server 130 determines a first quality metric of a target video to be distributed using a first evaluation model.

At block 420, the server 130 converts the target video into a plurality of first videos corresponding to a plurality of transcoding modes, the plurality of transcoding modes corresponding to different video encoding attributes.

At block 430, the server 130 determines, using a second evaluation model, quality loss information of the plurality of first videos with respect to the target video.

At block 440, the server 130 determines a plurality of second quality metrics of the plurality of first videos based on the quality loss information.

At block 450, the server 130 provides reference information associated with distributing the target video based at least on the first quality metric and the plurality of second quality metrics.

In some embodiments, converting the target video into the plurality of first videos corresponding to the plurality of transcoding modes includes: obtaining a second video by performing video enhancement processing on the target video; and converting the second video into the plurality of first videos corresponding to the plurality of transcoding modes.

In this way, the embodiments of the present disclosure can support performing video enhancement processing on the target video and obtaining the transcoded video based on the enhanced video, thereby improving the efficiency and quality of video processing.

In some embodiments, the process 400 further includes: determining, using the first evaluation model, a reference quality metric of the second video; and determining a third quality metric of the second video based on a quality difference between the reference quality metric and the first quality metric, wherein the reference information is further determined based on the third quality metric.

In this way, the embodiments of the present disclosure can support using the first evaluation model to evaluate the quality of the enhanced video, so that quality reference information associated with the process of enhancing the video can be provided, and the efficiency of video distribution can be improved.

In some embodiments, determining the third quality metric of the second video based on the difference between the reference quality metric and the first quality metric includes: mapping the quality difference to the third quality metric of the second video based on a predetermined mapping.

In this way, the embodiments of the present disclosure can support evaluating the quality of the enhanced video, which is beneficial to providing a reference for subsequent improvement of the video distribution process.

In some embodiments, the plurality of first videos are determined by transcoding the second video, and determining the plurality of second quality metrics of the plurality of first videos based on the quality loss information includes: determining the plurality of second quality metrics of the plurality of first videos based on the quality loss information and the third quality metric.

In this way, the embodiments of the present disclosure can support evaluating the quality of the transcoded video corresponding to the transcoding mode based on the quality loss information, so that reference information can be provided for determining the transcoding mode of the video during subsequent video distribution.

In some embodiments, determining, using the second evaluation model, the quality loss information of the plurality of first videos with respect to the target video includes: determining an encoding feature associated with the target video by pre-encoding the target video or the second video, the second video being determined by performing video enhancement processing on the target video; and providing the encoding feature to the second evaluation model to determine the quality loss information of the plurality of first videos with respect to the target video.

In this way, the embodiments of the present disclosure can support generating the transcoded video based on the enhanced video and evaluating the quality of the transcoded video.

In some embodiments, the reference information is further determined based on a fourth quality metric associated with playback of a third video corresponding to the target video by a client, the third video is determined based on the first video received by the client, and the fourth quality metric is determined through: determining, in response to the client performing super-resolution processing on the received first video to determine the third video, quality evaluation information of the third video using the second evaluation model, and determining, using a third evaluation model, super-resolution evaluation information associated with the first video; and determining the fourth quality metric associated with the third video based on the quality evaluation information and the super-resolution evaluation information.

In this way, the embodiments of the present disclosure can support quality evaluation of the video subjected to super-resolution processing at the client, so that reference information may be provided for selecting a super-resolution processing mode for the distributed video, which is beneficial to improving the efficiency and quality of video distribution.

In some embodiments, the video encoding attribute includes at least one of: a video resolution; a video encoding mode; and a video encoding rate.

In this way, the embodiments of the present disclosure support transcoding the video based on different video resolutions, video encoding modes, and/or video encoding rates, and support quality evaluation of videos obtained through transcoding based on different encoding attributes, so that quality information reference may be provided for a transcoding step of the distributed video.

In some embodiments, the first evaluation model corresponds to a no-reference evaluation mode, and the second evaluation model corresponds to a full-reference evaluation mode.

In this way, the embodiments of the present disclosure can combine the no-reference evaluation mode and the full-reference evaluation mode to monitor and evaluate the quality of each step in the video distribution process, thereby improving the monitoring precision of the video quality.

In some embodiments, providing the reference information associated with distributing the target video includes: presenting the reference information in a graphical interface, the reference information including at least the first quality metric and the plurality of second quality metrics.

In this way, the embodiments of the present disclosure can support providing the reference information associated with the target video to be distributed, which is beneficial to improving the efficiency and quality of video distribution.

In some embodiments, the reference information includes a video distribution recommendation generated based on the first quality metric and the plurality of second quality metrics.

In this way, the embodiments of the present disclosure can provide a distribution recommendation based on the quality determined in different steps of video distribution, thereby improving the efficiency and quality of video distribution.

In some embodiments, the first quality metric and the second quality metrics correspond to a same value range.

In this way, in the embodiments of the present disclosure, a same value range is used for quality evaluation of different steps of the processing process of the distributed video, and a unified evaluation scale is used for quality evaluation, which is beneficial to improving the information acquisition efficiency of processing quality of different steps, and thus improving the efficiency of optimization decision-making for different processes of the distributed video.

### EXAMPLE APPARATUS AND DEVICE

An embodiment of the present disclosure further provides a corresponding apparatus for implementing the above method or process. FIG. 5 illustrates a schematic structural block diagram of an example apparatus 500 for video distribution according to some embodiments of the present disclosure. The apparatus 500 may be implemented as or included in the electronic device 110. Each module/component in the apparatus 500 may be implemented by hardware, software, firmware, or any combination thereof.

As shown in FIG. 5, the apparatus 500 includes: a first determination module 510 configured to determine, using a first evaluation model, a first quality metric of a target video to be distributed; a converting module 520 configured to convert the target video into a plurality of first videos corresponding to a plurality of transcoding modes, the plurality of transcoding modes corresponding to different video encoding attributes; a second determination module 530 configured to determine, using a second evaluation model, quality loss information of the plurality of first videos with respect to the target video; a third determination module 540 configured to determine a plurality of second quality metrics of the plurality of first videos based on the quality loss information; and a providing module 550 configured to provide reference information associated with distributing the target video based at least on the first quality metric and the plurality of second quality metrics.

In some embodiments, the conversion module 520 is further configured to: obtain a second video perform video enhancement processing on the target video; and convert the second video into the plurality of first videos corresponding to the plurality of transcoding modes.

In some embodiments, the apparatus 500 further includes a fourth determination module. The fourth determination module is configured to: determine, using the first evaluation model, a reference quality metric of the second video; and determine a third quality metric of the second video based on a quality difference between the reference quality metric and the first quality metric, wherein the reference information is further determined based on the third quality metric.

In some embodiments, the fourth determination module is further configured to map the quality difference to the third quality metric of the second video based on a predetermined mapping.

In some embodiments, the plurality of first videos are determined by transcoding the second video, and the fourth determination module is further configured to determine the plurality of second quality metrics of the plurality of first videos based on the quality loss information and the third quality metric.

In some embodiments, the second determination module 530 is further configured to: determine an encoding feature associated with the target video by pre-encoding the target video or the second video, the second video being determined by performing video enhancement processing on the target video; and provide the encoding feature to the second evaluation model to determine the quality loss information of the plurality of first videos with respect to the target video.

In some embodiments, the reference information is further determined based on a fourth quality metric associated with playback of a third video corresponding to the target video by a client, the third video is determined based on the first video received by the client, and the fourth quality metric is determined through: determining, in response to the client performing super-resolution processing on the received first video to determine the third video, quality evaluation information of the third video using the second evaluation model, and determining, using a third evaluation model, super-resolution evaluation information associated with the first video; and determining the fourth quality metric associated with the third video based on the quality evaluation information and the super-resolution evaluation information.

In some embodiments, the video encoding attribute includes at least one of: a video resolution, a video encoding mode, and a video encoding rate.

In some embodiments, the first evaluation model corresponds to a no-reference evaluation mode, and the second evaluation model corresponds to a full-reference evaluation mode.

In some embodiments, the providing module 550 is further configured to present the reference information in a graphical interface, the reference information including at least the first quality metric and the plurality of second quality metrics.

In some embodiments, the reference information includes a video distribution recommendation generated based on the first quality metric and the plurality of second quality metrics.

In some embodiments, the first quality metric and the second quality metrics correspond to a same value range.

The units included in the apparatus 500 may be implemented in various ways, including software, hardware, firmware, or any combination thereof. In some embodiments, one or more units may be implemented using software and/or firmware, for example, machine-executable instructions stored on a storage medium. In addition to machine-executable instructions or as an alternative, some or all units in the apparatus 500 may be implemented at least partially by one or more hardware logic components. As an example, rather than a limitation, example types of hardware logic components that may be used include a field programmable gate array (FPGA), an application specific integrated circuit (ASIC), an application specific standard (ASSP), a system on chip (SOC), a complex programmable logic device (CPLD), and so on.

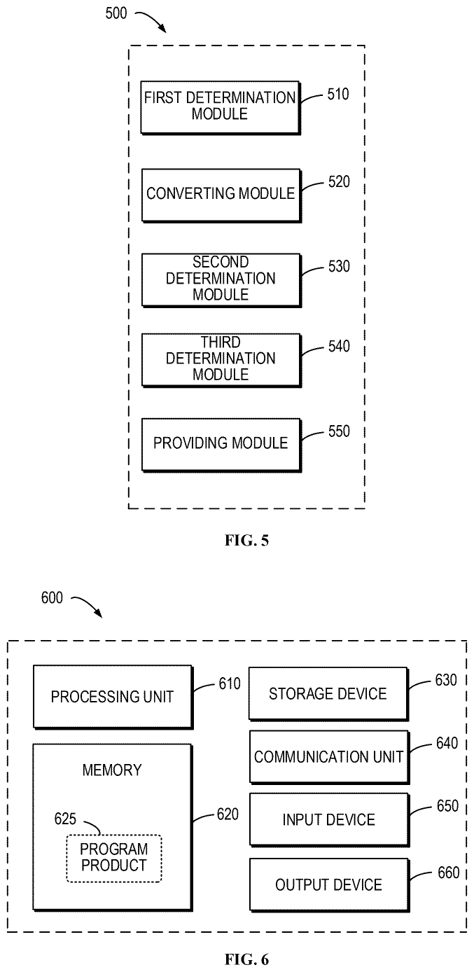

FIG. 6 illustrates a block diagram of an electronic device 600 in which one or more embodiments of the present disclosure may be implemented. It should be understood that the electronic device 600 shown in FIG. 6 is only illustrative, without suggesting any limitation to the function and scope of the embodiments described herein. The electronic device 600 shown in FIG. 6 may be used to implement the electronic device 110 of FIG. 1.

As shown in FIG. 6, the electronic device 600 is in the form of a general electronic device. The components of the electronic device 600 may include but are not limited to one or more processors or processing units 610, a memory 620, a storage device 630, one or more communication units 640, one or more input devices 650, and one or more output devices 660. The processing unit 610 may be an actual or virtual processor, and may perform various processing based on the program stored in the memory 620. In a multi-processor system, a plurality of processing units execute computer executable instructions in parallel to improve the parallel processing capability of the electronic device 600.

The electronic device 600 typically includes a plurality of computer storage medium. Such medium may be any available medium that is accessible to the electronic device 600, including but not limited to volatile and non-volatile medium, removable and non-removable medium. The memory 620 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be removable or non-removable medium, and may include a machine-readable medium such as a flash drive, a disk, or any other medium, which may be used to store information and/or data and may be accessed within the electronic device 600.

The electronic device 600 may further include additional removable/non-removable, volatile/non-volatile memory medium. Although not shown in FIG. 6, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 620 may include a computer program product 625, which has one or more program modules configured to perform various methods or acts of various embodiments of the present disclosure.

The communication unit 640 implements communication with other electronic devices through a communication medium. In addition, the functions of the components of the electronic device 600 may be implemented by a single computing cluster or a plurality of computing machines, which may communicate through communication connections. Therefore, the electronic device 600 may use a logical connection with one or more other servers, a network personal computer (PC), or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) through the communication unit 640 as needed, the external devices such as a storage device, a display device, etc., communicate with one or more devices that enable the user to interact with the electronic device 600, or communicate with any devices (such as a network card, a modem, etc.) that enable the electronic device 600 to communicate with one or more other electronic devices. Such communication may be performed via input/output (I/O) interfaces (not shown).

According to an illustrative implementation of the present disclosure, a computer-readable storage medium is provided, on which computer-executable instructions are stored, where the computer-executable instructions are executed by a processor to implement the method described above. According to an illustrative implementation of the present disclosure, there is further provided a computer program product, which is tangibly stored on a non-transitory computer-readable medium and includes computer-executable instructions, and the computer-executable instructions are executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowchart and/or block diagram, and each combination of blocks in the flowchart and/or block diagram may be implemented by computer-readable program instructions.

These computer-readable program instructions may be provided to a processing unit of a general-purpose computer, a special-purpose computer, or other programmable data processing apparatus to produce a machine, so that when these instructions are executed by the processing unit of the computer or other programmable data processing apparatus, an apparatus for implementing the functions/acts specified in one or more blocks of the flowchart and/or block diagram is produced. These computer-readable program instructions may also be stored in a computer-readable storage medium, and these instructions cause the computer, the programmable data processing apparatus, and/or other devices to work in a specific manner, so that the computer-readable medium storing the instructions includes a manufactured product, which includes instructions for implementing various aspects of the functions/acts specified in one or more blocks of the flowchart and/or block diagram.

The computer-readable program instructions may be loaded onto a computer, other programmable data processing apparatus, or other devices, so that a series of operation steps are performed on the computer, other programmable data processing apparatus, or other devices to produce a computer-implemented process, so that the instructions executed on the computer, other programmable data processing apparatus, or other devices implement the functions/acts specified in one or more blocks of the flowchart and/or block diagram.

The flowchart and block diagram in the drawings show the possibly implemented architectures, functions, and operations of the systems, methods, and computer program products according to a plurality of implementations of the present disclosure. In this regard, each block in the flowchart or block diagram may represent a module, program segment, or part of an instruction, and the module, program segment, or part of the instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and each combination of blocks in the block diagram and/or the flowchart may be implemented by a special-purpose hardware-based system that executes specified functions or acts, or may be implemented by a combination of special-purpose hardware and computer instructions.

Various implementations of the present disclosure have been described above, and the above description is illustrative, non-exhaustive, and is not limited to the disclosed implementations. Without departing from the scope and spirit of the illustrated implementations, many modifications and changes will be apparent to those of ordinary skill in the art. The terminology used herein has been chosen to best explain the principles of each implementation, the actual application or improvement to the technology in the market, or to enable other those of ordinary skill in the art to understand the various implementations disclosed herein.

1. A method of video distribution, comprising:
determining, using a first evaluation model, a first quality metric of a video to be distributed;
converting the video to be distributed into a plurality of first videos corresponding to a plurality of transcoding modes, the plurality of transcoding modes corresponding to different video encoding attributes;
determining, using a second evaluation model, quality loss information of the plurality of first videos with respect to the video to be distributed;
determining a plurality of second quality metrics of the plurality of first videos based on the quality loss information; and
providing reference information associated with distributing the video to be distributed based at least on the first quality metric and the plurality of second quality metrics.

2. The method of claim 1, wherein converting the video to be distributed into the plurality of first videos corresponding to the plurality of transcoding modes comprises:
obtaining a second video by performing video enhancement processing on the video to be distributed; and
converting the second video into the plurality of first videos corresponding to the plurality of transcoding modes.

3. The method of claim 2, further comprising:
determining, using the first evaluation model, a reference quality metric of the second video; and
determining a third quality metric of the second video based on a quality difference between the reference quality metric and the first quality metric, wherein the reference information is further determined based on the third quality metric.

4. The method of claim 3, wherein determining the third quality metric of the second video based on the difference between the reference quality metric and the first quality metric comprises:
mapping the quality difference to the third quality metric of the second video based on a predetermined mapping.

5. The method of claim 3, wherein the plurality of first videos are determined by transcoding the second video, and determining the plurality of second quality metrics of the plurality of first videos based on the quality loss information comprises:
determining the plurality of second quality metrics of the plurality of first videos based on the quality loss information and the third quality metric.

6. The method of claim 1, wherein determining, using the second evaluation model, the quality loss information of the plurality of first videos with respect to the video to be distributed comprises:
determining an encoding feature associated with the video to be distributed or a second video by pre-encoding the video to be distributed or the second video, the second video being determined by performing video enhancement processing on the video to be distributed; and
providing the encoding feature to the second evaluation model to determine the quality loss information of the plurality of first videos with respect to the video to be distributed.

7. The method of claim 1, wherein the reference information is further determined based on a fourth quality metric associated with playback of a third video corresponding to the video to be distributed by a client, the third video is determined based on the first video received by the client, and the fourth quality metric is determined through:
determining, in response to the client performing super-resolution processing on the received first video to determine the third video, quality evaluation information of the third video using the second evaluation model, and determining, using a third evaluation model, super-resolution evaluation information associated with the first video; and
determining the fourth quality metric associated with the third video based on the quality evaluation information and the super-resolution evaluation information.

8. The method of claim 1, wherein the video encoding attribute comprises at least one of:
a video resolution;
a video encoding mode; and
a video encoding rate.

9. The method of claim 1, wherein the first evaluation model corresponds to a no-reference evaluation mode, and the second evaluation model corresponds to a full-reference evaluation mode.

10. The method of claim 1, wherein providing the reference information associated with distributing the video to be distributed comprises:
presenting the reference information in a graphical interface, the reference information comprising at least the first quality metric and the plurality of second quality metrics.

11. The method of claim 1, wherein the reference information comprises a video distribution recommendation generated based on the first quality metric and the plurality of second quality metrics.

12. The method of claim 1, wherein the first quality metric and the second quality metrics correspond to a same value range.

13. An electronic device, comprising:
at least one processor; and
at least one memory coupled to the at least one processor and storing instructions executable by the at least one processor, the instructions, when executed by the at least one processor, causing the electronic device to perform acts comprising:
determining, using a first evaluation model, a first quality metric of a video to be distributed;
converting the video to be distributed into a plurality of first videos corresponding to a plurality of transcoding modes, the plurality of transcoding modes corresponding to different video encoding attributes;
determining, using a second evaluation model, quality loss information of the plurality of first videos with respect to the video to be distributed;
determining a plurality of second quality metrics of the plurality of first videos based on the quality loss information; and
providing reference information associated with distributing the video to be distributed based at least on the first quality metric and the plurality of second quality metrics.

14. The electronic device of claim 13, wherein converting the video to be distributed into the plurality of first videos corresponding to the plurality of transcoding modes comprises:
obtaining a second video by performing video enhancement processing on the video to be distributed; and
converting the second video into the plurality of first videos corresponding to the plurality of transcoding modes.

15. The electronic device of claim 14, wherein the acts further comprise:
determining, using the first evaluation model, a reference quality metric of the second video; and
determining a third quality metric of the second video based on a quality difference between the reference quality metric and the first quality metric, wherein the reference information is further determined based on the third quality metric.

16. The electronic device of claim 15, wherein determining the third quality metric of the second video based on the difference between the reference quality metric and the first quality metric comprises:
mapping the quality difference to the third quality metric of the second video based on a predetermined mapping.

17. The electronic device of claim 15, wherein the plurality of first videos are determined by transcoding the second video, and determining the plurality of second quality metrics of the plurality of first videos based on the quality loss information comprises:
determining the plurality of second quality metrics of the plurality of first videos based on the quality loss information and the third quality metric.

18. The electronic device of claim 13, wherein determining, using the second evaluation model, the quality loss information of the plurality of first videos with respect to the video to be distributed comprises:
determining an encoding feature associated with the video to be distributed or a second video by pre-encoding the video to be distributed or the second video, the second video being determined by performing video enhancement processing on the video to be distributed; and
providing the encoding feature to the second evaluation model to determine the quality loss information of the plurality of first videos with respect to the video to be distributed.

19. The electronic device of claim 13, wherein the reference information is further determined based on a fourth quality metric associated with playback of a third video corresponding to the video to be distributed by a client, the third video is determined based on the first video received by the client, and the fourth quality metric is determined through:
determining, in response to the client performing super-resolution processing on the received first video to determine the third video, quality evaluation information of the third video using the second evaluation model, and determining, using a third evaluation model, super-resolution evaluation information associated with the first video; and
determining the fourth quality metric associated with the third video based on the quality evaluation information and the super-resolution evaluation information.

20. A non-transitory computer-readable storage medium having a computer program stored thereon, the computer program being executable by a processor to implement acts comprising:
determining, using a first evaluation model, a first quality metric of a video to be distributed to be distributed;
converting the video to be distributed into a plurality of first videos corresponding to a plurality of transcoding modes, the plurality of transcoding modes corresponding to different video encoding attributes;
determining, using a second evaluation model, quality loss information of the plurality of first videos with respect to the video to be distributed;
determining a plurality of second quality metrics of the plurality of first videos based on the quality loss information; and
providing reference information associated with distributing the video to be distributed based at least on the first quality metric and the plurality of second quality metrics.
